(19) United States
(12) Patent Application Publication
(10) Pub. No.: US 2006/0193539 A1
(43) Pub. Date: Aug. 31, 2006

(54) Kitty doodley disposal bag

(76) Inventor: Andrea Small, Saluda, NC (US)

Correspondence Address: Wilson Daniel Swayze, Jr., 3804 Clearwater Court, Plano, TX, 75025, US

(21) Appl. No.: 11/067,845

(22) Filed: Feb. 28, 2005

(51) Int. Cl. B65D 33/00; B65D 33/30; B65D 30/16; B65D 30/08

(52) U.S. Cl. 383/33; 383/109; 383/104; 383/91

(57) ABSTRACT

A container for the collection of cat waste includes a liner bag for collecting the cat waste, a body for supporting the liner bag having an opened position and a closed position and an edge for maintaining the liner bag in the open position.

### BACKGROUND

The collection and disposal of solid excrement or waste which is known as doodley from cats presents many problems for their owners. Placing this waste in a container or bag is a solution, but this solution presents additional problems. One problem is that the bag should prevent the waste from escaping the bag. Furthermore, one additional problem is that the bag should prevent odor from escaping the bag. The escaping odor causes a problem for the owner of the cat.

An additional problem is that the bag does not remain open while the owner of the cat tries to place the waste into the bag.

### SUMMARY

The present invention provides solutions to these problems. More particularly, the present invention provides a solution to the disposal of waste from cats. The present invention provides a bag that prevents the odor from escaping the bag. Additionally, the present invention provides a solution to the problem of keeping the bag open. The present invention includes a bag with a metal edge that keeps the bag open while the waste is being placed in the bag. The present invention holds its shape while scooping and will not leak. The present invention includes a liner bag which is sealable and will have low or no odor while it is being stored in a trash can.

### BRIEF DESCRIPTION OF THE DRAWINGS

FIG. 1 illustrates a front view of the bag;

FIG. 2 illustrates a bottom view of the bag; and

FIG. 3 illustrates a side view of the bag.

### DETAILED DESCRIPTION

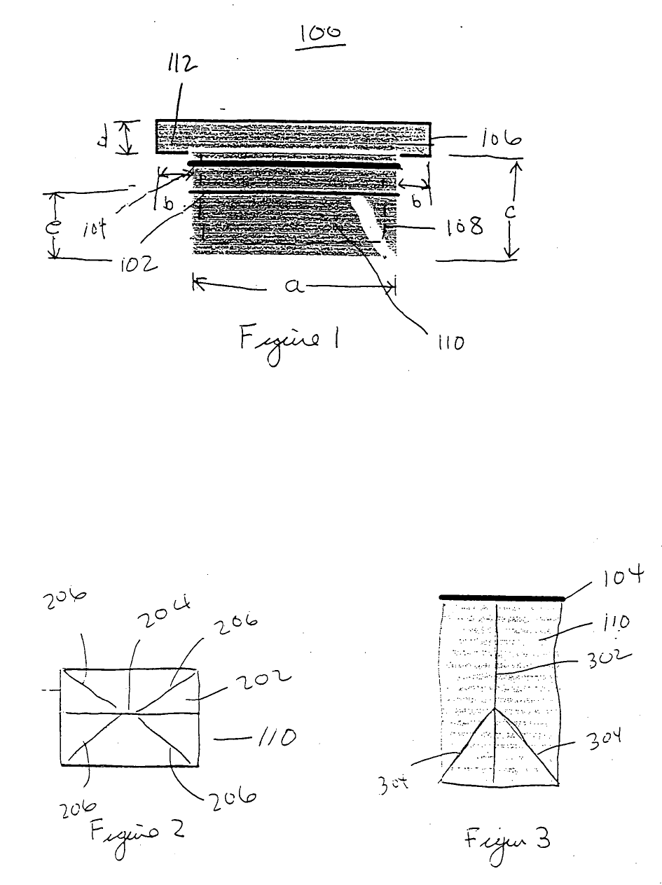

FIG. 1 shows a front view of a bag 100 or container of the present invention. The bag 100 includes a body 110 which could be made of a flexible material such as paper, for example brown paper, or plastic and is open at the top while closed at the bottom and tape 106 to prevent odor from escaping. The body 110 includes a fill mark 102 to indicate when the body 110 is filled with waste. The body 110 includes a metal edge 104 which is located approximately at the top of the body 110 and which is attached to the body 110. The metal edge 104 is to keep the bag 100 open while waste is being placed into the bag 100. Within the bag 100 is a liner bag 108 which could be made from plastic to prevent the body from being soiled by the waste. Within the bag 100 is a liner bag 108 to prevent the body 110 from being soiled by the waste. The bag 100 includes tape 106 to seal the body 110. The bag 100 is then to be placed into the trash to be disposed of. The tape 106 could be made from plastic so that the tape can be bent over on itself to keep the bag 100 closed and then returned to its original shape in preparation to be reused. The liner bag 108 should be sufficiently long to extend to the tape 106 so that when the tape ends 112 are folded inwards, the liner bag 108 is supported so that the liner bag 108 does not collapse and spilled the waste into the body 110. The liner bag 108 seals to prevent odor from escaping.

The tape 106 extends beyond the edge of the body 110 and is reinforced to allow the tape to be bent and returned to it's original shape.

The ends 112 of the tape 106 may extend beyond the width of the bag 100 so that the tape includes a tie down and may be folded over on itself to keep the bag 100 closed; other embodiments could have the tape 106 extends only to the edge of the body 110.

FIG. 2 illustrates a bottom view of the body 110. Element 202 illustrates the bottom of the body 110 and includes fold lines 204, 206. The fold line 204 extends across the bottom 202 of the body 110. The fold lines 206 extend from the corners of the bottom 202 approximately the center of the bottom 202.

FIG. 3 illustrates a side view of the body 110. Across the top of the body 110 is the metal edge 104, body 110 includes side fold lines 302 and 304. The side fold line 302 extends from the top to the bottom of body 110 while side fold lines 304 extends from the bottom corners of the body 110 to the side fold line 302.

FIG. 1 additionally illustrates the dimensions of the bag 100. The bottom of the body 100 is a, where a is approximately 10 inches. The side of body 100 is c where c 10 inches. A dimension d and b is approximately 2 inches. The dimension e is approximately 6 inches. While specific dimensions have been given, other dimensions are within the scope of the present invention.

And while this invention has been described in terms of several embodiments and the advantages of this invention have been described in detail, it should be understood that changes, substitutions, transformations, modifications, and other variations can be made therein without departing from the teachings of the present invention and the scope and protection of the invention being set forth by the attached claims.

1) A container for the collection of cat waste, comprising:
a liner bag for collecting said cat waste,
a body for supporting said liner bag having a opened position and a closed position,
an edge for maintaining said liner bag in said open position.

2) A container for the collection of cat waste as in claim 1, wherein said body includes a fill line to indicate where the liner bag is full.

3) A container for the collection of cat waste as in claim 1, wherein said container includes a sealable tape to prevent odor from escaping.

4) A container for the collection of cat waste as in claim 1, wherein said edge folds over on itself.

5) A container for the collection of cat waste as in claim 1, wherein said bag is flexible.

6) A method for producing a container for the collection of cat waste, comprising the steps of:
forming a liner bag for collecting said cat waste,
forming a body for supporting said liner bag having an opened position and a closed position,
forming an edge for maintaining said liner bag in said open position.

7) A method for producing a container for the collection of cat waste as in claim 6, wherein said method includes forming a fill line to indicate where the liner bag is full.

8) A method for producing a container for the collection of cat waste as in claim 6, wherein said method includes forming a sealable tape to prevent odor from escaping.

9) A method for producing a container for the collection of cat waste as in claim 6, wherein said edge folds over on itself.

10) A system for the collection of cat waste, comprising:
a container;
a liner bag for collecting said cat waste,
a body for supporting said liner bag having an opened position and a closed position,
an edge for maintaining said liner bag in said open position.

11) A container for the collection of cat waste as in claim 10, wherein said body includes a fill line to indicate where the liner bag is full.

12) A system for the collection of cat waste as in claim 10, wherein said container includes a sealable tape to prevent odor from escaping.

13) A container for the collection of cat waste as in claim 10, wherein said edge folds over on itself.

14) A container for the collection of cat waste as in claim 10, wherein said bag is flexible.
